(19) United States
(12) Patent Application Publication
(10) Pub. No.: US 2024/0047160 A1
(43) Pub. Date: Feb. 8, 2024

(54) FAST-ACTING ACTUATOR DEVICE

(71) Applicant: ETO MAGNETIC GmbH, Stockach (DE)

(72) Inventors: Jörg BÜRSSNER, Engen (DE); Peter VINCON, Stockach (DE); Valerio RESCIGNO, Konstanz (DE); Benedikt FENDRICH, Konstanz (DE); Anthony LAVAL, Radolfzell (DE)

(21) Appl. No.: 18/255,527

(22) PCT Filed: Dec. 3, 2021
(86) PCT No.: PCT/EP2021/084185

§ 371 Date: Jun. 1, 2023

(30) Foreign Application Priority Data
Dec. 3, 2020 (DE) 10 2020 132 224.0

(51) Int. Cl. H01H 50/64; H01H 50/18; H01H 47/00

(52) U.S. Cl. CPC H01H 50/64; H01H 50/18; H01H 47/002

(57) ABSTRACT

A fast-acting actuator device (68), in particular circuit-breaker device, is proposed, has a mechanical tensioning element (10), has an armature element (12) which can be preloaded by the mechanical tensioning element (10) and which, driven by tension release of the mechanical tensioning element (10), is movable from at least one first end position (14) into at least one second end position (16), further has a magnet unit (18) which is configured to hold the armature element (12) in the first end position (14) by means of a magnetic field generated by the magnet unit (18), and has a resetting unit (20) which is configured to move the armature element (12) back at least from the second end position (16) into the first end position (14) by means of a motor-drivable resetting element (22) and, in the process, to preload the mechanical tensioning element (10).

### PRIOR ART

The invention relates to a fast-acting actuator device according to claim 1, an actuator according to claim 29, and a method according to claim 30.

Electromagnetic actuators are already known. However, the switching speeds of electromagnetic actuators are limited, in particular for larger strokes.

The object of the invention is, in particular, to provide a generic device with advantageous properties with regard to a switching speed and/or with regard to an achievable stroke. According to the invention, the object is achieved by the features of claims 1, 29 and 30, while advantageous embodiments and developments of the invention can be found in the dependent claims.

### Advantages of the Invention

A preferably fast-acting actuator device, in particular a circuit breaker device, having a mechanical tensioning element, having an armature element which can be preloaded by the mechanical tensioning element and which, driven by tension release of the mechanical tensioning element, is movable from at least one first end position into at least one second end position, having a magnet unit which is configured to hold the armature element, preferably directly, in the first end position by means of a magnetic field generated by the magnet unit, and having a resetting unit which is configured to move the armature element back at least from the second end position into the first end position by means of a motor-drivable resetting element and, in the process, to preload the mechanical tensioning element, in particular in comparison with a state of the mechanical actuating element in the second end position. Advantageously, this allows a particularly fast actuating movement (for example <6 ms) to be achieved in at least one actuating direction, in particular with an advantageously large stroke (for example >7 mm). Advantageously, the design of the actuator device enables the fast actuating movement with the large stroke in a particularly small installation space, in particular in relation to the achievable stroke.

In particular, the actuator device forms at least a part, in particular a subassembly, of an actuator having an armature element mechanically moved at least in one actuating direction. In particular, the actuator device forms at least a part, in particular a subassembly, of a monostable actuator. In particular, the actuator device is designed as a monostable actuator device. Advantageously, the actuator device is configured at least for use in a circuit breaker (safeguard), in particular in a motor vehicle circuit breaker, preferably in a battery circuit breaker. For example, the actuator device can form a circuit breaker of a motor vehicle electrical system. In particular, the mechanical tensioning element is formed as a mechanical spring element, for example as a compression spring, in particular as a spiral compression spring, or the like. Furthermore, an “armature element” shall be understood to mean a component which, during an operation of the actuator device, is configured to exert a movement which determines the function of the actuator, for example a triggering of the disconnection of an electric circuit, in particular a safety disconnection of the electric circuit. In particular, the armature element can be influenced, in particular moved, by a spring force of the mechanical tensioning element. In particular, the armature element has a spring seat on which the mechanical tensioning element is supported with one end. Preferably, the armature element can be influenced by means of a magnetic signal, in particular a magnetic field. In particular, a movement of the armature element can be restricted by the magnetic field, preferably the magnetic field at least temporarily prevents a movement of the armature element. In particular, the armature element is configured to perform a linear movement, preferably exclusively a linear movement. In particular, when the armature element is in the first end position, the mechanical tensioning element is tensioned, preferably maximally tensioned (length-compressed), at least compared to the state of the mechanical tensioning element when the armature element is in the second end position. In particular, when the armature element is in the second end position, the mechanical tensioning element is relaxed, at least compared to the state of the mechanical tensioning element when the armature element is in the first end position. In particular, the mechanical tensioning element is configured to at least predominantly or exclusively drive the first actuating movement of the armature element by a spring force.

In particular, “configured” is to mean specially programmed, designed and/or equipped. If an object is configured for a certain function, this shall be understood in particular to mean that the object fulfills and/or executes this certain function in at least one application and/or operating state.

In particular, the magnet unit is configured to prevent movement of the tensioning element as a function of the generated magnetic field. In particular, the magnet unit is configured to generate a magnetic field that exerts a holding force on the armature element that acts against the spring force of the mechanical tensioning element. In particular, the magnet unit does not generate a force driving the actuating movements of the armature element. In particular, the magnet unit holds the armature element in the first end position indirectly, for example by controlling a state or position of a locking element or detent element holding the armature element in the first end position, or preferably directly, for example by a direct attracting interaction with a magnetically active part of the armature element. In particular, the resetting element is configured to mechanically push or press the armature element from the second end position to the first end position. In particular, the resetting unit comprises a motor drive, for example an electric motor generating a rotational movement or an electric linear motor. In particular, the motor-drivable resetting element is connected to the motor drive via a type of transmission for transmitting the drive force.

It is further proposed that a first actuating movement generated by the tension release of the mechanical tensioning element, in which at least the armature element moves from the first end position to the second end position, generates a stroke of at least 7 mm within at most 6 ms. Advantageously, this allows a particularly fast switching with a particularly large stroke to be generated by the actuator device. Preferably, the first actuating movement generates a stroke of at least 10 mm within at most 4 ms.

It is also proposed that a second actuating movement generated by the resetting unit for resetting the mechanical tensioning element, in which at least the armature element moves from the second end position to the first end position, is substantially slower, preferably at least 40 times, preferably at least 75 times, and particularly preferably at least 100 times slower, than the first actuating movement. Advantageously, this allows the armature element to be reset in a way that protects the materials involved. Advantageously, this can ensure a long service life of the actuator device and/or achievement of optimum functionality of the actuator device over a long period of time. In particular, a duration of the second actuating movement is in the range of several hundred milliseconds (for example in a range of approximately 200 ms to 600 ms).

Furthermore, it is proposed that the resetting unit is configured to control, in particular as an alternative to the first actuating movement proceeding independently of the resetting unit, a third actuating movement in which the armature element moves from the first end position to the second end position substantially slower, preferably at least 40 times, preferably at least 75 times, and particularly preferably at least 100 times slower, than in the first actuating movement proceeding independently of the resetting unit. Advantageously, this enables an additional controlled movement of the armature element from the first end position to the second end position, for example for a controlled disconnection/separation of an electric circuit. Advantageously, this means that not every movement of the armature element from the first end position to the second end position has to take place at maximum actuating speed, so that the components of the actuator device can thereby be advantageously protected. Advantageously, a service life can be increased. For example, when the actuator device is used in a motor vehicle electrical system, the third actuating movement can enable a controlled disconnection (for example when the motor vehicle is parked), while the first actuating movement is configured for an emergency disconnection (for example in the event of an accident or the like). In particular, during the third actuating movement, the armature element is moved into the second end position by means of the motor-driven resetting element with a controlled tension release of the mechanical actuating element.

It is further proposed that the magnet unit comprises an electromagnet which, at least in the activated state, is configured to exert an attracting force effect on at least part of the armature element to fix the armature element in the first end position. As a result, a deenergized fail-safe position of the actuator device in the second end position can advantageously be achieved. In particular, in the activated state, the electromagnet holds the armature element in the first end position against the spring force of the mechanical tensioning element. In particular, the armature element comprises a magnetic element which is configured to interact with the magnetic field of the magnet unit by attraction. In particular, the magnetic element is at least partially formed of a ferromagnetic material. In particular, the magnetic element is integrated into the armature element. Alternatively, the magnetic element may be formed separately from the armature element and preferably connected to the armature element. Furthermore, as an alternative to the direct interaction of the electromagnet with the part of the armature element, it is also conceivable that instead the magnet unit comprises a permanent magnet which interacts with at least a part of the armature element by attraction, wherein the magnetic field of the permanent magnet could be superimposed on a switching magnetic field of the electromagnet for releasing the fixation of the armature element in the first end position. In this case, instead of the deenergized fail-safe position of the actuator device in the second end position, a deenergized fail-safe position of the actuator device in the first end position could advantageously be achieved. In particular, the electromagnet is fixed relative to a housing unit of the actuator device, preferably fixed to the housing unit. In particular, the armature element is supported so as to be movable relative to the housing unit, and is in particular supported so as to be movable inside the housing unit.

If the actuator device has the housing unit which encloses at least a large portion of the electromagnet and at least a large portion of the armature element and/or at least a large portion of the mechanical tensioning element, advantageously a simple assembly and/or fitting into a limited installation space can be made possible. Advantageously, a high compactness of the actuator device can be achieved, in particular in relation to the achievable stroke. In particular, the mechanical tensioning element is arranged completely inside the housing unit. In particular, the armature element is arranged completely inside the housing unit, with the exception of an actuating element which is moved by the armature element and may be formed integrally with the armature element. In particular, only the actuating element protrudes beyond the housing unit as the only component of the actuator device. In particular, the magnet unit, preferably at least the electromagnet, is arranged completely inside the housing unit. In particular, the motor drive for driving the resetting element is arranged completely inside the housing unit. In particular, the housing unit comprises a cover element. The cover element can in particular be removable, but preferably the cover element is firmly (form-fittingly) connected to the housing unit, for example plastics-welded or pressed or the like.

It is also proposed that the electromagnet is arranged at least substantially laterally adjacent to the mechanical tensioning element with respect to an expansion direction of the mechanical tensioning element. In this way, a particularly high degree of compactness can advantageously be achieved, in particular with respect to the expansion direction of the mechanical actuating element and/or with respect to an extension parallel to the actuating directions of the armature element. The expansion direction of the mechanical tensioning element runs in particular parallel to a longitudinal extension of the mechanical tensioning element, parallel to a spiral axis of the mechanical tensioning element and/or parallel to the actuating directions of the armature element.

In addition, it is proposed that the resetting unit, in particular the motor-drivable resetting element, has a driver element that is supported movably, in particular relative to the housing unit of the actuator device, for contacting the armature element during an actuating movement by the resetting unit. As a result, an advantageous and/or simple transmission of force from the motor drive to the armature element and thus in particular to the mechanical tensioning element can be achieved. In particular, the driver element follows all movements performed by the motor-drivable resetting element. In particular, the driver element is fixedly connected to the motor-drivable resetting element. In particular, the driver element is formed separately from the armature element. In particular, the driver element is arranged without contact with the armature element in at least one operating state of the actuator device.

If the motor-drivable resetting element is formed as a gearwheel, a particularly advantageous and/or simple force transmission from the motor drive to the driver element and/or to the resetting element can be achieved. In particular, an axis of rotation of the gearwheel is oriented at least substantially perpendicular to the actuating directions of the armature element and/or to the expansion direction of the mechanical actuating element. In particular, an axis of rotation of the gearwheel is oriented at least substantially perpendicular to a coil axis of the electromagnet.

If, in addition, the driver element is arranged on a side face of the gearwheel and thus follows a movement of the gearwheel, an effective and/or simple force transmission from the motor drive to the armature element can be advantageously achieved during the second or third positioning movement. In particular, the driver element is arranged on a side face of the gearwheel in such a way that it describes a circular path during rotation of the gearwheel. In particular, the driver element is arranged outside an innermost quarter, preferably outside an innermost third and preferably outside an inner half of a radius of the side face of the gearwheel, so that an optimized ratio of transmittable force (torque) and achievable travel, in particular an achievable component of the circular path in a direction parallel to the actuating directions, can be advantageously achieved.

It is further proposed that the driver element is configured to entrain the armature element over at least 120°, preferably over at least 160°, of a monotonic rotational movement of the gearwheel and/or over at most 170°, preferably at most 130°, of the monotonic rotational movement of the gearwheel. In this way, a particularly effective tensioning of the mechanical tensioning element can be advantageously achieved, for example in that the greatest possible stroke can be advantageously transmitted through the gearwheel to the armature element. A “monotonic rotational movement” is to be understood in particular to mean a constant or intermittent movement with a constant direction of rotation. In particular, the driver element is always free from contact with the armature element over a part of the circular path describable by the driver element that encompasses at least 120°, preferably at least about 180°.

If the driver element is configured to release the armature element following entrainment, in particular after a transfer position for transferring the armature element to the magnet unit has been reached, by a rotational movement of the gearwheel, in particular by a continuation of the rotational movement of the gearwheel, the armature element can advantageously be released in a particularly simple manner for a rapid displacement to the first end position following the reset process. In this context, “release” of the armature element is to be understood in particular as meaning that the driver element is arranged inside the housing unit in such a way that collisions of the driver element with the armature element are ruled out when the first positioning movement is completed. In particular, in this case the driver element is arranged outside a movement volume swept over by the armature element during the first positioning movement.

If, in addition, the armature element has a contact element for receiving a force exerted by the driver element on the armature element, the contact element being configured to be at least partially swept over by the driver element during the actuating movement by the resetting unit, an effective and/or simple transmission of force from the motor drive, in particular from the driver element to the armature element, can advantageously take place. In particular, the contact element is realized integrally, preferably monolithically, with the armature element. In particular, the contact element is formed as a lug-like projection of the armature element oriented in the direction of the gearwheel.

It is additionally proposed that the armature element comprises at least one first armature sub-element and a second armature sub-element connected to the first armature sub-element, said second armature sub-element being arranged at least substantially perpendicular to the first armature sub-element, wherein the contact element is arranged on the first armature sub-element and wherein the second armature sub-element comprises at least one seat, in particular the spring seat, for supporting the mechanical tensioning element and/or at least the magnetic element, which is configured to interact with the magnetic field of the magnet unit by attraction. Thus, an advantageous construction of the armature element can be achieved. Advantageously, a particularly compact design of the actuator device can be achieved, in particular in relation to the achievable stroke. In particular, the first armature sub-element and the second armature sub-element are formed at least integrally, preferably monolithically, with respect to each other. The expression “integrally” is in particular to mean connected at least in an integrally bonded manner, for example by a welding process, an adhesive process, an injection molding process and/or another process which appears to a person skilled in the art to be reasonable, and/or advantageously formed in a single piece, such as by a production from a casting and/or by a production in a single-component or multi-component injection molding process and advantageously from an individual blank. In particular, the first armature sub-element and/or the second armature sub-element is extended in a planar manner, in particular in a plate-like manner.

If, in this case, the seat, in particular the spring seat, for supporting the mechanical tensioning element and the magnetic element are arranged, relative to the first armature sub-element, on opposite sides of the first armature sub-element, a particularly advantageous compactness can be achieved, in particular with respect to the expansion direction of the mechanical actuating element and/or with respect to an extent parallel to the actuating directions of the armature element.

If, in addition, at least one reinforcing element, by means of which the first armature sub-element, which in particular is arranged at least substantially in a T-shape relative to the second armature sub-element, is supported and reinforced on the second armature sub-element at least on a side facing towards the seat for supporting the mechanical tensioning element, a high stability of the armature element can advantageously be achieved. In particular, due to an off-center arrangement of the spring seat in the armature element and an off-center effect of the spring force on the armature element caused thereby and/or due to an off-center arrangement of the magnetic element in the armature element, torsional and/or bending loads may occur within the armature element, which can advantageously be at least partially absorbed by the reinforcing elements. In particular, the reinforcing elements form supporting bevels or supporting wedges.

It is also proposed that the armature element has a guide element, which is molded on integrally, for receiving and/or guiding the mechanical tensioning element. In this way, a high level of operational reliability can be advantageously achieved, in particular in that a position and movement of the mechanical tensioning element can be precisely specified. In particular, the guide element is formed as a cylindrical elevation of the armature element. In particular, at least part of the mechanical tensioning element surrounds the guide element.

It is also proposed that the mechanical tensioning element is formed as a spiral spring, in particular a spiral compression spring, wound at least section-wise and/or partially around the guide element. In this way, a high level of operational reliability can be advantageously achieved, in particular in that a position and movement of the spiral spring can be precisely specified.

It is further proposed that the fast-acting actuator device has the actuating element, which is at least operatively connected to the armature element and is preferably formed integrally with the armature element, and which is arranged on a side of the armature element opposite the mechanical tensioning element. In this way, an optimized utilization of the large stroke for an actuating movement can be advantageously achieved. In particular, the actuating element is configured to interrupt an electric circuit and/or actuating a switch which leads to an interruption of an electric circuit. In particular, the actuating element is in a maximally extended state when the armature element is in the second end position. In particular, the maximally extended state forms a trigger position of the actuating element, which is configured to bring about or cause an interruption of the electric circuit. In particular, the actuating element is in a minimally extended state when the armature element is in the first end position. In particular, the minimally extended state forms a safety position of the actuating element in which the electric circuit is not interrupted by the actuating element. In particular, the mechanical tensioning unit and resetting unit drive the movement of the actuating element.

It is further proposed that the fast-acting actuator device comprises an electric motor, which is configured to generate a drive force for moving the resetting element. This can advantageously allow a controlled tensioning of the mechanical tensioning element. In particular, the electric motor is arranged at least partially, preferably completely, in the housing unit. In particular, the electric motor is supplied with current via a common current input of the housing unit and/or a common current feedthrough of the housing unit in the same way as the electromagnet.

If the fast-acting actuator device additionally has a worm gear, which is configured to transmit the drive force of the electric motor to the resetting element, in particular to the gearwheel, a particularly compact design of the actuator device can be advantageously achieved, in particular in relation to the achievable stroke. In particular, the worm gear has a worm wheel which is arranged at an output of the electric motor generating a rotational movement. In particular, the worm wheel meshes with the resetting element formed as a gearwheel to convert the rotational movement of the output of the electric motor into a rotational movement of the gearwheel, the axis of rotation of which preferably extends at least substantially perpendicularly to the axis of rotation of the output of the electric motor. The expression “substantially perpendicularly” is here in particular intended to define an orientation of a direction relative to a reference direction, wherein the direction and the reference direction, in particular as viewed in a projection plane, form an angle of 90° and the angle has a maximum deviation of in particular less than 8°, advantageously less than 5°, and particularly advantageously less than 2°.

If, in addition, the electric motor is configured to generate a reverse rotation for a controlled transfer of the armature element from the first end position to the second end position, in particular guided by the driver element, the controlled movement of the armature element from the first end position to the second end position can advantageously be enabled. Advantageously, this can advantageously protect the components of the actuator device. Advantageously, a service life of the actuator device can be increased.

In addition, it is proposed that the fast-acting actuator device has a sensor unit, in particular with at least one sensor, which is configured to detect and/or monitor at least one state, in particular at least the end positions of the armature element, and/or a movement of the armature element. Advantageously, this can allow precise monitoring and/or control of the movement and/or the position of the armature element. Advantageously, a high level of operational safety can be achieved.

If the sensor unit, preferably at least one sensor of the sensor unit, is configured to detect and/or monitor a motor current of an electric motor of the resetting unit for determining a reset time of the resetting unit within which the armature element is brought from the second end position to the first end position, for determining a current position of a driver element of the resetting unit, such as an angular position of the driver element or a vertical position of the driver element, and/or for determining a travel path of the driver element of the resetting unit, a precise condition monitoring of the actuator device can advantageously be achieved. Advantageously, malfunctions can thus be detected and/or avoided. In particular, the sensor is configured to perform a ripple count method for determining the current position and/or travel path of the actuating element. In particular, the sensor of the sensor unit is formed as an asynchronous counter (ripple counter), which is configured to detect and evaluate a structure of the motor current of the electric motor, for example a ripple of the motor current. In particular, the asynchronous counter is configured to use a number of detected patterns (for example ripples) in the motor current to infer a number of revolutions of the motor and thus the current position and/or travel path of the driver element.

Furthermore, it is proposed that the sensor unit comprises a Hall sensor, which is configured to monitor a movement at least of a portion of the resetting element for determining the reset time of the resetting unit, the current position of the driver element and/or the travel path of the driver element. Advantageously, this allows precise condition monitoring of the actuator device to be achieved. Advantageously, malfunctions can thus be detected and/or avoided. In particular, the sensor unit comprises a magnet element, which is preferably formed as a permanent magnet. In particular, the Hall sensor is configured to detect a magnetic field of the magnet element, preferably changes in the magnetic field of the magnet element (for example, changes in a magnetic field strength of the magnet element at the location of the Hall sensor, changes in a magnetic field direction of the magnet element at the location of the Hall sensor, changes in a location of the magnet element relative to the Hall sensor, etc.). In particular, the Hall sensor is configured to determine the current position of the resetting element, in particular the driver element, and/or a travel path of the resetting element, in particular the driver element, based on the detected change in the magnetic field of the magnet element. The magnet element may, for example, be integrated in the resetting element and/or in the driver element. Preferably, in this case, the magnet element is integrated into the resetting element and/or into the driver element in such a way that a movement of the resetting element and/or of the driver element causes a movement of the magnet element. Alternatively, the magnet element may be arranged, for example, on a side of the resetting element that is opposite a side of the resetting element on which the Hall sensor is arranged. In this case, the resetting element and/or the driver element is formed in part of a magnetic-flux-conducting material, for example of a ferromagnetic material, so that the magnetic field of the magnet unit is differently shaped, preferably differently conducted through the resetting element and/or the driver element, depending on the current position of the resetting element and/or the driver element, and/or the travel path of the resetting element and/or the driver element.

It is further proposed that the sensor unit is configured to detect a transfer position of the resetting unit and/or the armature element, in which the armature element is transferred to the magnet unit after a reset by the resetting unit. Advantageously, this allows precise condition monitoring of the actuator device. Advantageously, malfunctions can thus be detected and/or avoided. Advantageously, a high operational reliability can be achieved. In particular, the Hall sensor is configured to detect the transfer position. In particular, the transfer position is designed as the position of the resetting unit, in particular of the driver element, in which the driver element has moved the armature element into the first end position. In particular, the transfer position is designed as the position of the resetting unit, in particular of the driver element, in which the driver element has a minimum vertical distance from the housing unit, in particular from the cover unit, along the circular path described by the driver element.

Advantageously, if the sensor unit is configured to detect an induction signal for identifying the transfer position, a simple and/or reliable detection of the transfer position can be enabled. In particular, the induction signal is formed as an electrical signal generated by a magnetic field or by a change in a magnetic field, for example a change in the magnetic field as the result of a movement of a ferromagnetic component in a magnetic field.

In this context, it is also proposed that the sensor unit is formed at least partially integrally with the electromagnet, in which the induction signal is generated by an approach of the armature element to the electromagnet, in particular by an approaching of the magnetic element integrated in the armature element or fixed to the armature element and/or of a further magnet element towards the electromagnet. Advantageously, this can allow simple and/or reliable detection of the transfer position. Advantageously, a transfer position can be enabled without the need for an additional sensor, such as the Hall sensor. Advantageously, a simple, cost-optimized and/or compact design of the actuator device can thus be achieved. Where it is stated that the two units are formed “partially integrally”, this shall be understood to mean in particular that the units have at least one, in particular at least two, advantageously at least three, common elements which are a component, in particular a functionally important component, of both units.

Furthermore, an actuator, in particular a circuit breaker, with the fast-acting actuator device is proposed. This makes it advantageous to obtain an actuator with a particularly fast actuating movement in at least one actuating direction, in particular with an advantageously large stroke.

In addition, a method is proposed with the fast-acting actuator device, in particular with the circuit breaker device, with a tensioning step in which an armature element is moved by a motor-driven resetting unit into a first end position held stable, preferably directly, by a magnetic field, as a result of which a mechanical tensioning element supported on the armature element is tensioned at the same time, and with a first tension-release step and a second tension-release step, which can be carried out as an alternative to the first tension-release step, wherein in the first tension-release step the armature element is released from the first end position and is moved with an uncontrolled acceleration into the second end position by the mechanical tensioning element, and wherein in the second tension-release step the armature element is released from the first end position and is moved by the mechanical tensioning element with an acceleration controlled by the resetting unit into the second end position, wherein the first tension-release step is configured for an emergency actuation of the fast-acting actuator device, in particular for triggering a safety disconnection of the circuit breaker device, while the second tension-release step is configured for a regular actuation of the fast-acting actuator device, in particular for triggering an orderly disconnection of the circuit breaker device. Thus, advantageously, the expansion of the mechanical actuating element can be used for a simultaneous implementation of an emergency mode with the fast first actuating movement and a control mode with the controlled, slower, third actuating movement. Advantageously, the additional enabling of the controlled switching process can result in material protection and thus a long service life.

In this regard, the actuator device according to the invention, the actuator according to the invention, and the method according to the invention shall not be limited to the application and embodiment described above. In particular, the actuator device according to the invention, the actuator according to the invention, and the method according to the invention may have a number of individual elements, components, and units that deviates from a number specified herein in order to fulfill an operating principle described herein.

### DRAWINGS

Further advantages can be found in the following description of the drawings. The drawings show an exemplary embodiment of the invention. The drawings, the description and the claims contain numerous features in combination. A person skilled in the art will expediently also consider the features individually and combine them to form useful further combinations.

In the drawings:

FIG. 1 shows a schematic side view of an actuator with a fast-acting actuator device,

FIG. 2 shows a schematic view of the fast-acting actuator device with a first hidden part of a housing unit and with an armature element located in a first end position,

FIG. 3 shows a further schematic view of the fast-acting actuator device with a second hidden part of the housing unit, with the armature element located in the first end position and with a driver element, a resetting unit, located in a release position,

FIG. 4 shows a schematic view of the fast-acting actuator device with the first hidden part of the housing unit, with a partially hidden magnet unit, and with an armature element located in a second end position,

FIG. 5 shows a schematic view of a part of the fast-acting actuator device with the armature element and with the resetting element of the resetting unit,

FIG. 6 shows a schematic perspective view of the armature element, and

FIG. 7 shows a schematic flow diagram of a method.

### DESCRIPTION OF THE EXEMPLARY EMBODIMENT

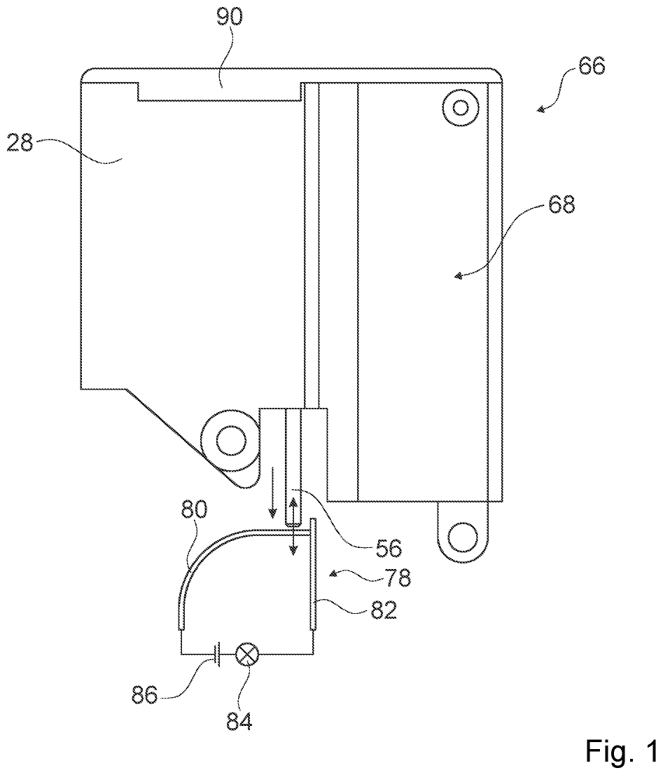

FIG. 1 shows a schematic side view of an actuator 66. The actuator 66 is formed as a circuit breaker. The actuator 66 is configured to interrupt an electric circuit 78 in at least one switching state. The electric circuit 78 illustrated by way of example comprises a first contact element 80 and a second contact element 82. The electric circuit 78 illustrated by way of example comprises a consumer 84 (for example, a motor vehicle electrical system) and a voltage source 86 (for example, an accumulator of a motor vehicle, in particular of an electric vehicle). In the case illustrated by way of example, the first contact element 82 is elastically resilient. The actuator 66 is configured to deflect (in the drawing of FIG. 1, pressing down) the first contact element 82 by an actuating element 56 of the actuator 66 in the operating state in which the electric circuit 78 is interrupted, so that the electrical contact with the second contact element 82 is disconnected and so that the voltage source 86 is disconnected from the consumer 84. The actuator 66 comprises a fast-acting actuator device 68.

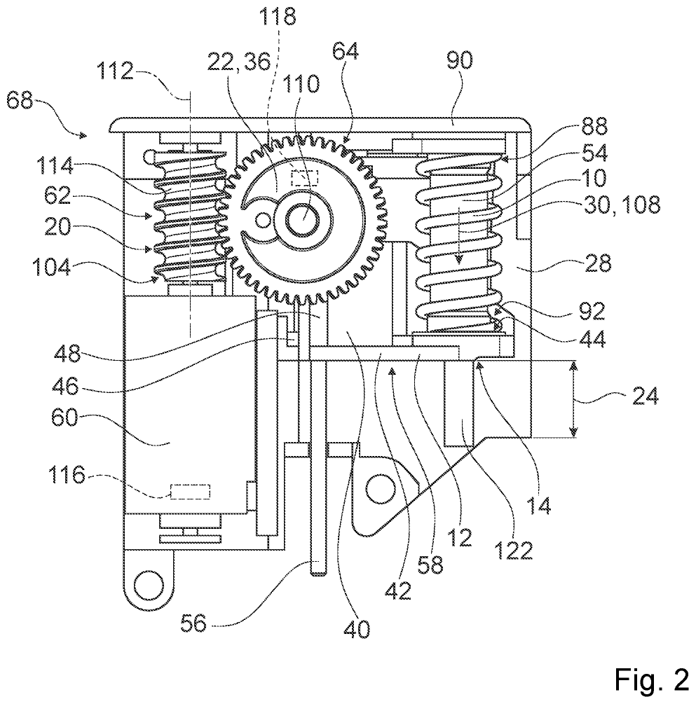

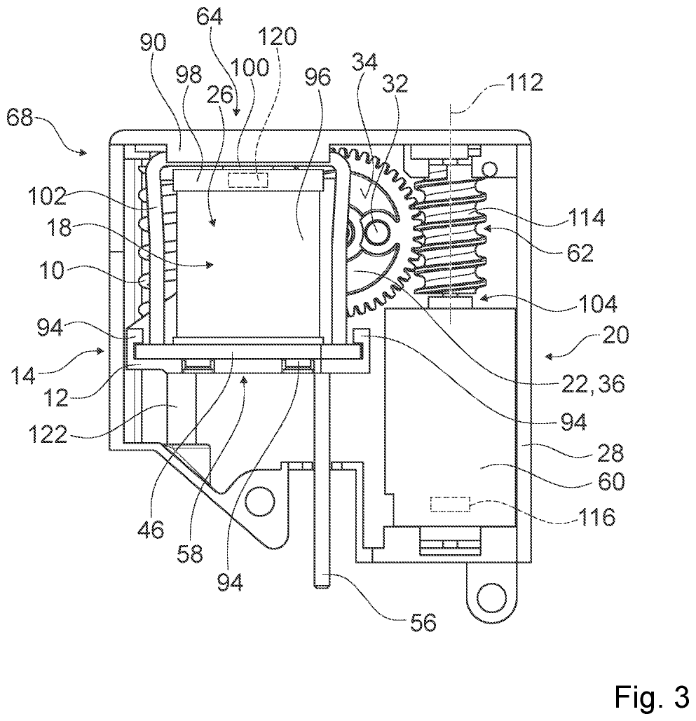

FIG. 2 shows a schematic view of the fast-acting actuator device 68 with the housing unit 28 partially hidden. The actuator device 68 is formed as a circuit breaker device. The actuator device 68 has the housing unit 28. The housing unit 28 encloses the actuator device 68 to a large extent. The housing unit 28 comprises a removable cover element 90. The actuator device 68 comprises a mechanical tensioning element 10. The mechanical tensioning element 10 is formed as a spiral compression spring. The mechanical tensioning element 10 is supported with a first end 88 on the housing unit 28, in particular on the cover element 90, preferably on a spring seat of the housing unit 28 or of the cover element 90. Alternatively, the mechanical tensioning element 10 may also be supported on a component of the actuator device 68 other than the cover element for example on a magnetic core 100 of an electromagnet 26 of the actuator device 68 or on a magnetic-flux conducting element 102 of the electromagnet 26 of the actuator device 68. In this case, an increased overall stability can advantageously be achieved by a support on a metallic hard component instead of on a plastics component. The mechanical tensioning element 10 is arranged entirely inside the housing unit 28. The actuator device 68 has an armature element 12. The armature element 12 (with the exception of the actuating element 56, which may be formed integrally with the armature element 12) is arranged entirely inside the housing unit 28. The armature element 12 is formed as an injection-molded part. A second end 92 of the mechanical tensioning element 10 is supported on the armature element 12. The armature element 12 can be preloaded by the mechanical tensioning element 10, in particular in a first end position 14 (cf. FIG. 2 and FIG. 3). The armature element 12 is in the first end position 14 in the illustration of FIG. 2. The armature element 12 is driven to move from the first end position 14 into a second end position 16 of the armature element 12 (cf. FIG. 4) by a tension release of the mechanical tensioning element During a first actuating movement, the armature element 12 moves from the first end position 14 into the second end position 16. The first actuating movement is generated by a tension release of the mechanical tensioning element 10. The first positioning movement forms a fast positioning movement, in which a stroke 24 of at least 7 mm is swept over by the armature element 12 within at most 6 ms. The armature element 12 has a guide element 54, which is configured to receive and/or to guide the mechanical tensioning element 10. The guide element 54 is molded to the armature element 12 integrally. The mechanical tensioning element in particular the spiral compression spring, is wound around the guide element 54 section-wise. The guide element 54 (or alternatively another guide element) is further configured for guiding the movement of the armature element 12. The actuator device 68 has a guide rod 122. The armature element 12 is movable along a longitudinal direction of the guide rod 122 inside the housing unit 28. The guide element 54 surrounds the guide rod 122 at least section-wise. The actuator device 68 has the actuating element 56. The actuating element 56 is operatively connected to the armature element 12. The actuating element 56 is arranged on the armature element 12 on a side 58 of the armature element 12 opposite the mechanical tensioning element 10.

The actuator device 68 has a magnet unit 18 (see in particular also FIG. 3). The magnet unit 18 is configured to hold the armature element 12 in the first end position 14 by means of a magnetic field generated by the magnet unit 18. The magnet unit 18 is arranged entirely inside the housing unit 28. The magnet unit 18 is immovably fixed relative to the housing unit 28. The magnet unit 18 is fixed to the cover element 90. Alternatively, the magnet unit 18 may be arranged and/or fixed to a component of the actuator device 68 other than the cover element 90, for example to the magnet core 100 or to the magnetic-flux conducting element 102. The magnet unit 18 comprises the electromagnet 26. The electromagnet 26 is arranged entirely inside the housing unit 28. The electromagnet 26 is arranged laterally adjacent to the mechanical tensioning element 10 with respect to an expansion direction 30 of the mechanical tensioning element 10. The electromagnet 26 has a coil winding 96 (shown only schematically). The electromagnet 26 has a coil former 98. The coil winding 96 is wound around the coil former 98. The electromagnet 26 has the magnetic core 100 disposed in an interior of the coil former 98. In the activated state, i.e. in the energized state, the electromagnet 26 is configured to exert an attractive force effect on at least a part of the armature element 12 for fixing the armature element 12 in the first end position 14. The actuator device 68 has a magnetic element 46. The magnetic element 46 is formed as a ferromagnetic plate, for example an iron plate. The magnetic element 46 is fixed to the armature element 12. The magnetic element 46 is latched in the armature element 12 by latching elements 94 of the armature element 12. In the activated state, the electromagnet 26 is configured to exert an attracting force effect on the magnetic element 46 for fixing the armature element 12 in the first end position 14. The electromagnet 26 comprises the bow-shaped magnetic-flux conducting element 102 open in the direction of the magnet element 46.

The actuator device 68 has a resetting unit 20. The resetting unit 20 is configured to move the armature element 12 back from the second end position 16 to the first end position 14. The resetting unit 20 is configured to bias the mechanical tensioning element 10 when the armature element 12 is moved towards the second end position 16. The second actuating movement generated by the resetting unit 20 for resetting the mechanical tensioning element 10, in which the armature element 12 moves back from the second end position 16 to the first end position 14, is at least 40 times slower than the first actuating movement, in which the armature element 12 moves from the first end position 14 to the second end position 16 driven by the mechanical tensioning element 10. A switching time of the second actuating movement is longer than 200 ms. The resetting unit 20 has a resetting element 22.

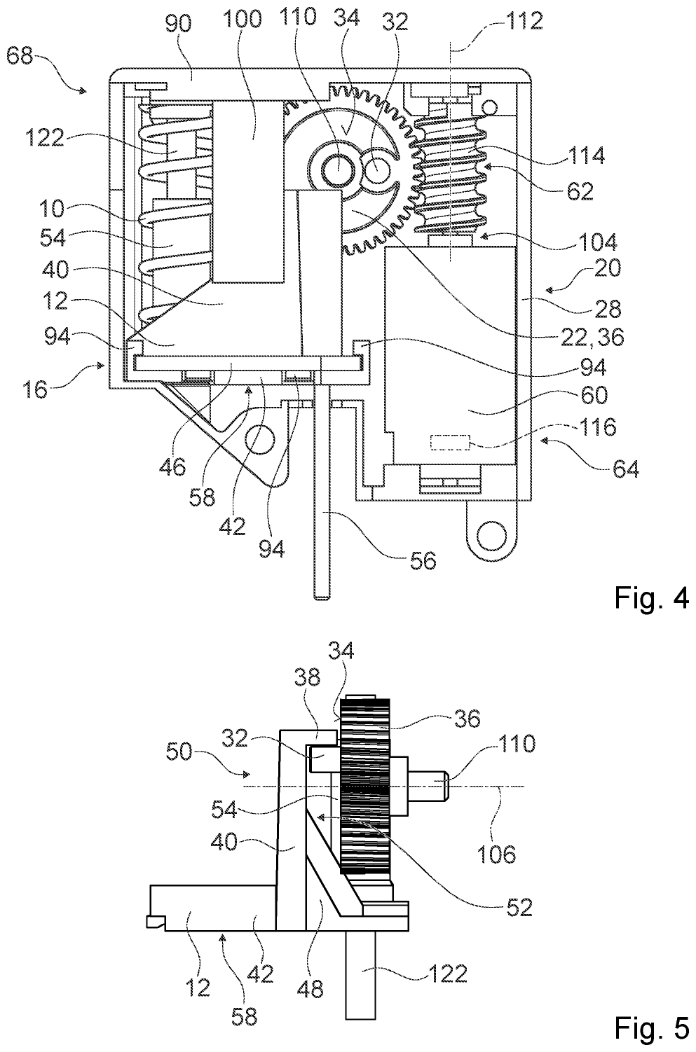

The resetting element 22 is motor-drivable. The motor-drivable resetting element 22 is formed as a gearwheel 36. The gearwheel 36 has an axis of rotation 106 (cf. also FIG. 5), which is oriented perpendicular to a main direction of movement 108 of the armature element 12. The main direction of movement 108 of the armature element 12 is parallel to the expansion direction 30 of the mechanical tensioning element 10. The resetting element 22 comprises a driver element 32. The driver element 32 is supported so as to be movable relative to the housing unit 28. The driver element 32 is configured to contact the armature element 12 during a positioning movement by the resetting unit 20. The driver element 32 is arranged on a side face 34 of the gearwheel 36. The driver element 32 is arranged off-center on the side face 34 of the gearwheel 36. The driver element 32 follows a movement of the gearwheel 36, and the driver element 32 is configured to drive the armature element 12 along at least 120° of a monotonic rotational movement of the gearwheel 36. The driver element 32 is configured to entrain the armature element 12 over at most 170° of a monotonic rotational movement of the gearwheel 36. The driver element 32 is formed as a kind of pin, which protrudes beyond the side face 34 of the gearwheel 36. The driving element 32 is formed as a kind of pin, which protrudes in the direction of the electromagnet 26 beyond the side face 34 of the gearwheel 36. The resetting element 22 has an axle element 110. The gearwheel 36 is supported so as to be rotatable about the axle element 110. The axle element 110 is, in turn, supported in/on the housing unit 28 in a positionally fixed manner. Alternatively, the axle element 110 may also be supported on a component of the actuator device 68 that is different from the housing unit 28, for example on the magnetic core 100 and/or the magnetic-flux conducting element 102. The driver element 32 is configured to release the armature element 12 following an entrainment of the armature element 12, by a rotational movement of the gearwheel 36, in particular by a continuation of the rotational movement of the gearwheel 36 generating the entrainment. When the armature element 12 is fixed in the first end position 14, the driver element 32, in particular the gearwheel 36, is rotated into a release position (cf. also FIG. 3).

The actuator device 68 has an electric motor 60. The electric motor 60 is configured to generate the drive force for moving the motor-drivable resetting element 22. The electric motor 60 is arranged entirely inside the housing unit 28. The electric motor 60 has an output 104. The output 104 has an axis of rotation 112. The axis of rotation 112 of the output 104 and the axis of rotation 106 of the gearwheel 36 extend in directions perpendicular to each other. The actuator device 68 has a worm gear 62. The worm gear 62 is configured to transmit the drive force of the electric motor 60 to the resetting element 22. The worm gear 62 has a gear ratio. The worm gear 62 comprises a worm shaft 114. The worm gear 62 comprises the gearwheel 36. The worm shaft 114 meshes with the gearwheel 36 to transmit drive energy and to change the orientation of the driven axis of rotation 106, 112.

The electric motor 60 is configured to generate a reverse rotation opposite to the reverse rotation direction used to return the armature element 12 from the second end position 16 to the first end position 14. The reverse rotation of the electric motor 60, in particular of the output 104, is configured for a controlled (slow) transfer of the armature element 12 from the first end position 14 to the second end position 16. The reverse rotation of the electric motor 60, in particular of the output 104, is configured for a transfer of the armature element 12 from the first end position 14 to the second end position 16, guided by the driver element 32. The resetting unit 20 is configured to control, by means of the backward rotation of the electric motor 60, as an alternative to the first actuating movement proceeding independently of the resetting unit 20, a third actuating movement in which the armature element 12 moves from the first end position 14 to the second end position 16 at least 40 times slower than in the first actuating movement proceeding independently of the resetting unit 20.

The actuator device 68 has a sensor unit 64. The sensor unit 64 is configured to detect and/or monitor a state and/or a movement of the armature element 12. The sensor unit 64 has a first sensor 116. The sensor unit 64 is configured to detect and/or monitor, by means of the first sensor 116, a motor current of the electric motor 60 of the resetting unit 20 for determining a reset time of the resetting unit within which the armature element 12 is brought from the second end position 16 to the first end position 14, for determining a current position of the driver element 32, and/or for determining a travel path of the driver element 32. The first sensor 116 is formed at least partially integrally with the electric motor 60 or with a control unit (not shown) for controlling the electric motor 60.

The sensor unit 64 has a second sensor 118. The sensor unit 64 has a Hall sensor. The second sensor 118 is formed as the Hall sensor. The second sensor 118 is configured to detect and/or monitor a movement at least of a portion of the resetting element 22 for determining the reset time of the resetting unit 20, the current position of the driver element 32, and/or the travel path of the driver element 32. In the exemplary case shown, the driver element 32 is partially formed as a permanent magnet. The second sensor 118 is configured to detect the magnetic field of the permanent magnet of the driver element 32 and to determine a position and/or a movement of the driver element 32 based on the currently detected magnetic field strength and/or the currently detected magnetic field direction of the magnetic field of the permanent magnet of the driver element 32.

The sensor unit 64 has a third sensor 120 (cf. FIG. 3). The third sensor 120 is configured to detect a transfer position of the resetting unit 20, in which the armature element 12 is transferred to the magnet unit 18 after being reset by the resetting unit 20. The third sensor 120 is configured to detect an induction signal for identifying the transfer position. In general, it is conceivable that two or more than two sensors 116, 118, 120 of the sensor unit 64 are formed at least partially integrally with each other. The third sensor 120 is formed integrally with the electromagnet 26. In the electromagnet 26, the induction signal is generated when the armature element 12 approaches the electromagnet 26. A control unit (not shown) of the electromagnet 26 is configured to read the induction signal from the electromagnet 26.

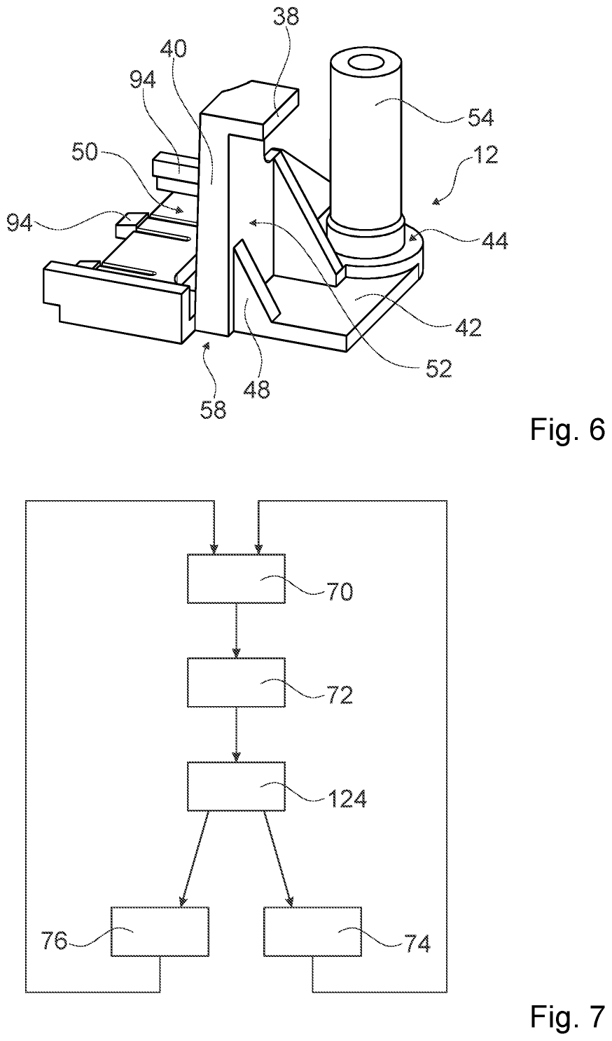

FIG. 6 shows a schematic perspective view of the armature element 12. The armature element 12 has a contact element 38. The contact element 38 is configured to receive a force exerted by the driver element 32 on the armature element 12. The contact element 38 is configured to be swept over by the driver element 32 during the second actuating movement by the resetting unit 20. The armature element 12 has a first armature sub-element 40 and a second armature sub-element 42 connected to the first armature sub-element 40. The two armature sub-elements 40, 42 have a plate-like extent for the most part. The second armature sub-element 42 is arranged perpendicular to the first armature sub-element 40. The contact element 38 is arranged on the first armature sub-element 40. The contact element 38 is formed as a lug projecting in a direction facing the gearwheel 36 beyond the remainder of the first armature sub-element 40. The second armature sub-element 42 forms a seat 44 for supporting the mechanical tensioning element 10. The second armature sub-element 42 comprises the guide element 54. The second armature sub-element 42 comprises the magnetic element 46, which is configured for interaction with the magnetic field of the magnet unit 18 by attraction. The second armature sub-element 42 has the latching elements 94. The seat 44 for supporting the mechanical tensioning element 10 and the magnetic element 46 are arranged on opposite sides 50, 52 of the first armature sub-element 40, as viewed relative to the first armature sub-element 40. The guide element 54 and the magnetic element 46 are disposed on opposite sides 50, 52 of the first armature sub-element 40 as viewed relative to the first armature sub-element 40. The actuator device 68 has a reinforcing element 48. The reinforcing element 48 is configured to support the first armature sub-element 40 against the second armature sub-element 42. The reinforcing element 48 is configured to support and reinforce the first armature sub-element 40 on the second armature sub-element 42, on a side 50 facing towards the seat 44 for supporting the mechanical tensioning element 10.

FIG. 7 shows a schematic flow diagram of a method with the fast-acting actuator device 68. In a tensioning step 70, the armature element 12 is moved by the motor-driven resetting element 22 into the first end position 14 held stable directly by the magnetic field. This closes the electric circuit 78 secured by the actuator 66. In the tensioning step 70, moreover, the mechanical tensioning element 10 supported on the armature element 12 is tensioned at the same time. In a further method step 72, the electromagnet 26 of the magnet unit 18 is activated. As a result, the armature element 12 is held in the first end position 14. In at least one further method step 124, the driver element 32 is removed from a path of movement of the armature element 12 by further rotation of the gearwheel 36. In a first tension-release step 74, the armature element 12 is released from the first end position 14. In the first tension-release step 74, the electromagnet 26 is deactivated. In the first tension-release step 74, the armature element 12 released from the first end position 14 is moved with an uncontrolled acceleration to the second end position 16 by the mechanical tensioning element 10. In the first tension-release step 74, the armature element 12 is moved at least 7 mm in at most 6 ms. In the first tension-release step 74, the movement of the armature element 12 opens the electric circuit 78 secured by the actuator 66. In the first tension-release step 74, the electric circuit 78 is opened abruptly before any (thermal) damage can occur or an electric shock can be triggered. The first tension-release step 74 is configured for emergency actuation of the fast-acting actuator device 68. In a second tension-release step 76, alternative to the first tension-release step 74, the armature element 12 is released from the first end position 14. In the second tension-release step 76, the electromagnet 26 is deactivated. In the second tension-release step 76, the armature element 12 released from the first end position 14 is moved to the second end position 16 by the mechanical tensioning element 10 with an acceleration controlled by the resetting unit 20. In the second tension-release step 76, the armature element 12 is moved at least 7 mm in at least 200 ms. In the second tension-release step 76, the movement of the armature element 12 opens the electric circuit 78 secured by the actuator 66 in a controlled manner. The second tension-release step 76 is configured for a regular actuation of the fast-acting actuator device 68.

### REFERENCE SIGNS

10 mechanical tensioning element
12 armature element
14 first end position
16 second end position
18 magnet unit
20 resetting unit
22 resetting element
24 stroke
26 electromagnet
28 housing unit
30 expansion direction
32 driver element
34 side face
36 gearwheel
38 contact element
40 first armature sub-element
42 second armature sub-element
44 seat
46 magnetic element
48 reinforcing element
50 side
52 side
54 guide element
56 actuating element
58 side
60 electric motor
62 worm gear
64 sensor unit
66 actuator
68 actuator device
70 tensioning step
72 method step
74 first tension-release step
76 second tension-release step
78 electric circuit
80 first contact element
82 second contact element
84 consumer
86 voltage source
88 first end
90 cover element
92 second end
94 latching element
96 coil winding
98 coil former
100 magnet core
102 magnetic-flux conducting element
104 output
106 rotation axis
108 main direction of movement
110 axle element
112 rotation axis
114 worm shaft
116 first sensor
118 second sensor
120 third sensor
122 guide rod
124 method step

1. A fast-acting actuator device, in particular circuit-breaker device, having a mechanical tensioning element, having an armature element which can be preloaded by the mechanical tensioning element and which, driven by tension release of the mechanical tensioning element, is movable from at least one first end position into at least one second end position, having a magnet unit which is configured to hold the armature element in the first end position by means of a magnetic field generated by the magnet unit, and having a resetting unit which is configured to move the armature element back at least from the second end position into the first end position by means of a motor-drivable resetting element and, in the process, to preload the mechanical tensioning element.

2. The fast-acting actuator device as claimed in claim 1, wherein a first actuating movement generated by the tension release of the mechanical tensioning element, in which at least the armature element moves from the first end position to the second end position, generates a stroke of at least 7 mm within at most 6 ms.

3. The fast-acting actuator device as claimed in claim 2, wherein a second actuating movement generated by the resetting unit for resetting the mechanical tensioning element, in which at least the armature element moves from the second end position to the first end position, is substantially slower, preferably at least 40 times slower, than the first actuating movement.

4. The fast-acting actuator device as claimed in claim 3, wherein the resetting unit is configured to control, in particular as an alternative to the first actuating movement proceeding independently of the resetting unit, a third actuating movement in which the armature element moves from the first end position to the second end position substantially slower, preferably at least 40 times slower, than in the first actuating movement proceeding independently of the resetting unit.

5. The fast-acting actuator device as claimed in claim 1, wherein the magnet unit comprises an electromagnet which, at least in the activated state, is configured to exert an attracting force effect on at least part of the armature element to fix the armature element in the first end position.

6. The fast-acting actuator device as claimed in claim 5, comprising a housing unit which encloses at least a large portion of the electromagnet and at least a large portion of the armature element and/or at least a large portion of the mechanical tensioning element.

7. The fast-acting actuator device as claimed in claim 5, wherein the electromagnet is arranged at least substantially laterally adjacent to the mechanical tensioning element with respect to an expansion direction of the mechanical tensioning element.

8. The fast-acting actuator device as claimed in claim 1, wherein the resetting unit, in particular the motor-drivable resetting element, has a driver element that is supported so as to be movable, in particular relative to a housing unit of the actuator device, for contacting the armature element during an actuating movement by the resetting unit.

9. The fast-acting actuator device as claimed in claim 1, wherein the motor-drivable resetting element is formed as a gearwheel.

10. The fast-acting actuator device as claimed in claim 8, wherein the motor-drivable resetting element is formed as a gearwheel and wherein the driver element is arranged on a side face of the gearwheel and thus follows a movement of the gearwheel.

11. The fast-acting actuator device as claimed in claim 10, wherein the driver element is configured to entrain the armature element over at least 120° of a monotonic rotational movement of the gearwheel and/or over at most 170° of the monotonic rotational movement of the gearwheel.

12. The fast-acting actuator device as claimed in claim 8, wherein the motor-drivable resetting element is formed as a gearwheel and wherein the driver element is configured to release the armature element following an entrainment by a rotational movement of the gearwheel, in particular by a continuation of the rotational movement of the gearwheel.

13. The fast-acting actuator device as claimed in claim 8, wherein the armature element has a contact element for receiving a force exerted by the driver element on the armature element, the contact element being configured to be at least partially swept over by the driver element during the actuating movement by the resetting unit.

14. The fast-acting actuator device as claimed in claim 13, wherein the armature element comprises at least one first armature sub-element and a second armature sub-element connected to the first armature sub-element, said second armature sub-element being arranged at least substantially perpendicular to the first armature sub-element, wherein the contact element is arranged on the first armature sub-element and wherein the second armature sub-element comprises at least one seat for supporting the mechanical tensioning element and/or at least one magnetic element, which is configured to interact with the magnetic field of the magnet unit by attraction.

15. The fast-acting actuator device as claimed in claim 14, wherein the seat for supporting the mechanical tensioning element and the magnetic element are arranged, relative to the first armature sub-element, on opposite sides of the first armature sub-element.

16. The fast-acting actuator device as claimed in claim 14, comprising at least one reinforcing element, by means of which the first armature sub-element is supported and reinforced on the second armature sub-element at least on a side facing towards the seat for supporting the mechanical tensioning element.

17. The fast-acting actuator device as claimed in claim 1, wherein the armature element has an integrally molded-on guide element for receiving and/or guiding the mechanical tensioning element.

18. The fast-acting actuator device as claimed in claim 17, wherein the mechanical tensioning element is formed as a spiral spring wound at least section-wise around the guide element.

19. The fast-acting actuator device as claimed in claim 1, comprising an actuating element, which is at least operatively connected to the armature element and is preferably formed integrally with the armature element, and which is arranged on a side of the armature element opposite the mechanical tensioning element.

20. The fast-acting actuator device as claimed in claim 1, comprising an electric motor, which is configured to generate a drive force for moving the resetting element.

21. The fast-acting actuator device as claimed in claim 20, comprising a worm gear, which is configured to transmit the drive force of the electric motor to the resetting element.

22. The fast-acting actuator device as claimed in claim 20, wherein the electric motor is configured to generate a reverse rotation for a controlled transfer of the armature element from the first end position to the second end position, in particular guided by the driver element.

23. The fast-acting actuator device as claimed in claim 1, comprising a sensor unit, which is configured to detect and/or monitor at least one state and/or a movement of the armature element.

24. The fast-acting actuator device as claimed in claim 23, wherein the sensor unit is configured to detect and/or monitor a motor current of an electric motor of the resetting unit for determining a reset time of the resetting unit within which the armature element is brought from the second end position to the first end position, for determining a current position of a driver element of the resetting unit, and/or for determining a travel path of the driver element of the resetting unit.

25. The fast-acting actuator device as claimed in claim 23, wherein the sensor unit comprises a Hall sensor, which is configured to monitor a movement at least of a portion of the resetting element for determining the reset time of the resetting unit, the current position of the driver element and/or the travel path of the driver element.

26. The fast-acting actuator device as claimed in claim 23, wherein the sensor unit is configured to detect a transfer position of the resetting unit, in which the armature element is transferred to the magnet unit after a reset by the resetting unit.

27. The fast-acting actuator device as claimed in claim 26, wherein the sensor unit is configured to detect an induction signal for identifying the transfer position.

28. The fast-acting actuator device as claimed in claim 27, wherein the magnet unit comprises an electromagnet which, at least in the activated state, is configured to exert an attracting force effect on at least part of the armature element to fix the armature element in the first end position and wherein the sensor unit is formed at least partially integrally with the electromagnet, in which the induction signal is generated by an approach of the armature element to the electromagnet.

29. An actuator, in particular circuit breaker, with a fast-acting actuator device as claimed in claim 1.

30. A method with a fast-acting actuator device, in particular with a circuit breaker device, in particular as claimed in claim 1.

31. The method as claimed in claim 30, with a tensioning step in which an armature element is moved by a motor-driven resetting unit into a first end position held stable, preferably directly, by a magnetic field, as a result of which a mechanical tensioning element supported on the armature element is tensioned at the same time, and with a first tension-release step and a second tension-release step, which can be carried out as an alternative to the first tension-release step, wherein in the first tension-release step the armature element is released from the first end position and moved with an uncontrolled acceleration into the second end position by the mechanical tensioning element, and wherein in the second tension-release step the armature element is released from the first end position and is moved by the mechanical tensioning element with an acceleration controlled by the resetting unit into the second end position.

32. The method as claimed in claim 31, wherein the first tension-release step is configured for an emergency actuation of the fast-acting actuator device, in particular for triggering a safety disconnection of the circuit breaker device, while the second tension-release step is configured for a regular actuation of the fast-acting actuator device, in particular for triggering an orderly disconnection of the circuit breaker device.
